(19) United States
(12) Patent Application Publication
(10) Pub. No.: US 2022/0377572 A1
(43) Pub. Date: Nov. 24, 2022

(54) Interpolation Method for Crowd-Sourced Electromagnetic Propagation Estimation of Indirect Paths

(71) Applicant: Google LLC, Mountain View, CA (US)

(72) Inventor: Preston Fairfax Marshall, Woodbridge, VA (US)

(73) Assignee: Google LLC, Mountain View, CA (US)

(21) Appl. No.: 17/663,945

(22) Filed: May 18, 2022

Related U.S. Application Data
(60) Provisional application No. 63/190,726, filed on May 19, 2021.

(51) Int. Cl. H04W 16/18

(52) U.S. Cl. CPC H04W 16/18

(57) ABSTRACT

A method to perform operations includes receiving an electromagnetic (EM) loss request requesting an EM loss between a first requested geographical point and a second requested geographical point. For each end geographical point in a set of different end geographical points that share a same source geographical point, the operations include obtaining a respective EM path loss value between the corresponding end geographical point and the source geographical point and generating a set of virtual loss lines. For each respective virtual loss line, the operations include determining a respective virtual EM loss based on the respective EM path loss values obtained for each end geographical point in the respective pair of end geographical points connected by the respective virtual loss line. The operations include estimating the EM loss between the first and second requested geographical points based on the virtual EM losses determined for the set of virtual loss lines.

### CROSS REFERENCE TO RELATED APPLICATIONS

This U.S. patent application claims priority under 35 U.S.C. § 119(e) to U.S. Provisional Application 63/190,726, filed on May 19, 2021. The disclosure of this prior application is considered part of the disclosure of this application and is hereby incorporated by reference in its entirety.

### TECHNICAL FIELD

This disclosure relates to interpolating crowd-sourced electromagnetic propagation for estimations of indirect paths.

### BACKGROUND

Accurate electromagnetic propagation modeling is becoming increasingly critical to both maximize effective use of scarce spectrum resources and to manage the deployment of wireless systems. Accurate electromagnetic propagation modeling typically requires very detailed data representations of terrain, structures, vegetation, and other impediments to electromagnetic signal energy. Thus, performing propagation modeling requires a large corpus of data that is both expensive and disruptive to obtain.

### SUMMARY

One aspect of the disclosure provides a computer-implemented method of interpolation for crowd-sourced electromagnetic propagation estimation of indirect paths. The method, when executed by data processing hardware, causes the data processing hardware to perform operations. The operations include receiving an electromagnetic (EM) loss request requesting an EM loss between a first requested geographical point and a second requested geographical point. The operations include, for each end geographical point in a set of different end geographical points that share a same source geographical point, obtaining a respective EM path loss value between the corresponding end geographical point and the source geographical point. The operations also include generating a set of virtual loss lines. Each virtual loss line in the set of virtual loss lines connects a different respective pair of end geographical points in the set of different end geographical points. For each respective virtual loss line in the set of virtual loss lines, the operations include determining a respective virtual EM loss based on the respective EM path loss values obtained for each end geographical point in the respective pair of end geographical points connected by the respective virtual loss line. The operations also include estimating the EM loss between the first requested geographical point and the second requested geographical point based on the virtual EM losses determined for the set of virtual loss lines.

Implementations of the disclosure may include one or more of the following optional features. In some implementations, the operations further include, after receiving the EM loss request, selecting the set of different end geographical points from a superset of end geographical points based on a location of the EM loss request. In some examples, the source geographical point corresponds to a location of a single emitter and each end geographical point in the set of different end geographical points corresponds to a different location of a receiver. In these examples, the receiver may include a mobile user device. In these examples, the single emitter may include a cellular base station.

In some implementations, the set of virtual loss lines includes a virtual loss line for every pair of end geographical points in the set of different end geographical points. Optionally, for each respective virtual loss line in the set of virtual loss lines, determining the respective virtual EM loss includes determining a difference between the two respective EM path loss values obtained for each end geographical point in the respective pair of end geographical points connected by the respective virtual loss line.

In some examples, the operations further include, for each respective EM path loss value, determining a free space loss value based on a distance between the corresponding end geographical point and the source geographical point and adjusting the respective EM path loss value based on the determined free space loss value. In these examples, adjusting the respective EM path loss value may include subtracting the determined free space loss value from the respective EM path loss value.

Optionally, the operations further include, after generating the set of virtual loss lines, determining a subset of virtual loss lines of the set of virtual loss lines that satisfy an aggregation threshold and, in response to determining that the subset of virtual loss lines satisfy the aggregation threshold, aggregating the subset of virtual loss lines into a single aggregated virtual loss line.

Another aspect of the disclosure provides a system of interpolation for crowd-sourced electromagnetic propagation estimation of indirect paths. The system includes data processing hardware and memory hardware in communication with the data processing hardware. The memory hardware stores instructions that when executed on the data processing hardware cause the data processing hardware to perform operations. The operations include receiving an electromagnetic (EM) loss request requesting an EM loss between a first requested geographical point and a second requested geographical point. The operations include, for each end geographical point in a set of different end geographical points that share a same source geographical point, obtaining a respective EM path loss value between the corresponding end geographical point and the source geographical point. The operations also include generating a set of virtual loss lines. Each virtual loss line in the set of virtual loss lines connects a different respective pair of end geographical points in the set of different end geographical points. For each respective virtual loss line in the set of virtual loss lines, the operations include determining a respective virtual EM loss based on the respective EM path loss values obtained for each end geographical point in the respective pair of end geographical points connected by the respective virtual loss line. The operations also include estimating the EM loss between the first requested geographical point and the second requested geographical point based on the virtual EM losses determined for the set of virtual loss lines.

This aspect may include one or more of the following optional features. In some implementations, the operations further include, after receiving the EM loss request, selecting the set of different end geographical points from a superset of end geographical points based on a location of the EM loss request. In some examples, the source geographical point corresponds to a location of a single emitter and each end geographical point in the set of different end geographical points corresponds to a different location of a receiver. In these examples, the receiver may include a mobile user device. In these examples, the single emitter may include a cellular base station.

In some implementations, the set of virtual loss lines includes a virtual loss line for every pair of end geographical points in the set of different end geographical points. Optionally, for each respective virtual loss line in the set of virtual loss lines, determining the respective virtual EM loss includes determining a difference between the two respective EM path loss values obtained for each end geographical point in the respective pair of end geographical points connected by the respective virtual loss line.

In some examples, the operations further include, for each respective EM path loss value, determining a free space loss value based on a distance between the corresponding end geographical point and the source geographical point and adjusting the respective EM path loss value based on the determined free space loss value. In these examples, adjusting the respective EM path loss value may include subtracting the determined free space loss value from the respective EM path loss value.

Optionally, the operations further include, after generating the set of virtual loss lines, determining a subset of virtual loss lines of the set of virtual loss lines that satisfy an aggregation threshold and, in response to determining that the subset of virtual loss lines satisfy the aggregation threshold, aggregating the subset of virtual loss lines into a single aggregated virtual loss line.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a system for interpolating crowd-sourced electromagnetic propagation for estimation of indirect paths.

FIGS. 2A and 2B are schematic views of a series of end geographical points associated with electromagnetic (EM) path loss values.

FIGS. 3A and 3B are schematic views of segmented end geographical points by proximity and receiver.

FIG. 4 is a schematic view of exemplary EM virtual crowed-sourced path measurements.

FIG. 5 is a flowchart of an example arrangement of operations for a method of interpolating crowd-sourced electromagnetic propagation for estimation of indirect paths.

FIG. 6 is a schematic view of an example computing device that may be used to implement the systems and methods described herein.

Like reference symbols in the various drawings indicate like elements.

### DETAILED DESCRIPTION

Accurate electromagnetic (EM) propagation modeling is critical to maximizing effective use of scarce spectrum resources and managing deployment of wireless systems (e.g., planning networks, predicting interference, and resolving service issues). However, multiple fundamental challenges plague the development of these propagation models. Primarily, these challenges arise from a lack of a large corpus of measurements to develop and calibrate models and the inability to tailor models to the characteristics that are unique to specific buildings and structures.

Conventional propagation models, and the process for developing them, suffer from a variety of drawbacks. For example, the data required to develop and calibrate propagation models is expensive and disruptive to obtain. Therefore, many propagation models in use today are not based on actual measurements, but instead are extrapolations of a limited number of measurements. These measurements are often at more than an octave or more difference in frequency in a limited (if any) set of attenuative environments. Moreover, the data typically includes only a relatively small number of data points that must be extrapolated in order to attempt to reflect a vast number of cases and situations.

To properly predict and address the wide range of conditions, frequencies, and locations necessary for deploying and supporting wireless network, the data to develop, train, and calibrate propagation models must be robust, plentiful, and reflective of the actual frequencies contemplated for use while also being inexpensive to obtain. Additionally, conventional propagation models are generic and tend to oversimplify complex situations rather than be specific to individual buildings, structures, and locations. For example, indoor/outdoor path loss is highly critical for a number of applications such as network planning and spectrum sharing, but generalized assumptions of indoor/outdoor path loss are almost all radically incorrect, as these values can vary from less than 1 dB to 50 dB or even greater than 100 dB. However, these variations are not reflected in current propagation models. As an example, a general propagation model cannot differentiate between a commercial or multi-dwelling unit with conventional six inch thick rebar concrete slab floors and the same general building with tensioned, pre-stressed concrete with only three inches of slab thickness. Yet this small (and not readily visible) engineering design difference may account for a reduction of inter-floor path loss of from 52 dB to 26 dB (respectively) and radically impact the ability to provide services between floors or to share spectrum between them. As the use of propagation models increasingly focuses on higher frequencies (e.g., 5G systems) and dense, urban capacity networks, typical methods of treating all buildings as if they are the same is increasingly inadequate. While such methods may be acceptable in some lower frequency coverage networks, they are wholly unsatisfactory for higher frequency capacity networks that are dominating the landscape today and in the future.

Implementations herein provide a virtual loss line generator that generates virtual paths in order to interpolate crowd-sourced data to obtain a path that was not present in the crowd-sourced data by interpolating the path from the points made available in the crowd-sourced data. Thus, the virtual loss line generator addresses a number of cases where it would be impractical or impossible to obtain direct measurements via crowd-sourcing data. For example, crowd-sourced data cannot “walk through” a wall or other obstacle that is basic to an EM propagation estimate.

In some implementations, the virtual loss line generator synthesizes sets of measurements from a corpus of crowd-sourced data. These measurements generally consist of a series of connected line segments, each of which represents a physically realizable path, driven by the accessibility to the source of the crowd-sourced data. Crowd-sourced data generally will not have a direct path across a building, through a single wall, between each of the interior spaces, etc. Thus, frequently a requested propagation estimate requires determining the loss in a path that has no direct analog in the crowd-sourced corpus, but is still essential to constructing a model for the EM prediction. For example, loss through a wall of a building may be critical to understand in/out transmission of power, yet no direct path through the wall likely exists for the crowd sourcing device. Similarly, the direct path through a building or other obstruction is often not accessible via crowd-sourced data, as the source of the data must instead move around or otherwise avoid the obstruction.

Moreover, it is likely that the source of the signal being reported has one or more unknown characteristics (power, location, antenna, etc.). Thus, the virtual loss line generator, in some examples, only utilizes actual measurements of the measuring device with no assumed knowledge of the signal being reported. The measuring device need only be able to identify the source to a level sufficient to differentiate between multiple possible sources. In some examples, the virtual loss line generator increases accuracy by determining the free space loss when distance information is available, but in a highly congested, attenuative environment, the path loss contribution of the free space loss is generally much less significant than the attenuation characteristics of the environment at frequencies above several GHz.

Additionally, the exact calibration of the reporting device is not typically known, and thus may have a wide range within devices among the same manufacturer. However, the relative calibration of signals from the same device (e.g., determining one received signal is 6 dB stronger than another received signal) is more uniform. Because of this, in some implementations, the virtual loss line generator does not rely on any calibration of the reporting devices and instead uses only the relative differences in signal strength from measurements. Thus, the virtual loss line generator operates independently of information defining the measured signal source and the calibration of the measuring device to create virtual crowd-sourced path measurements that provide the geometry necessary to compute an end-to-end path loss in either a two-dimension or three-dimension framework.

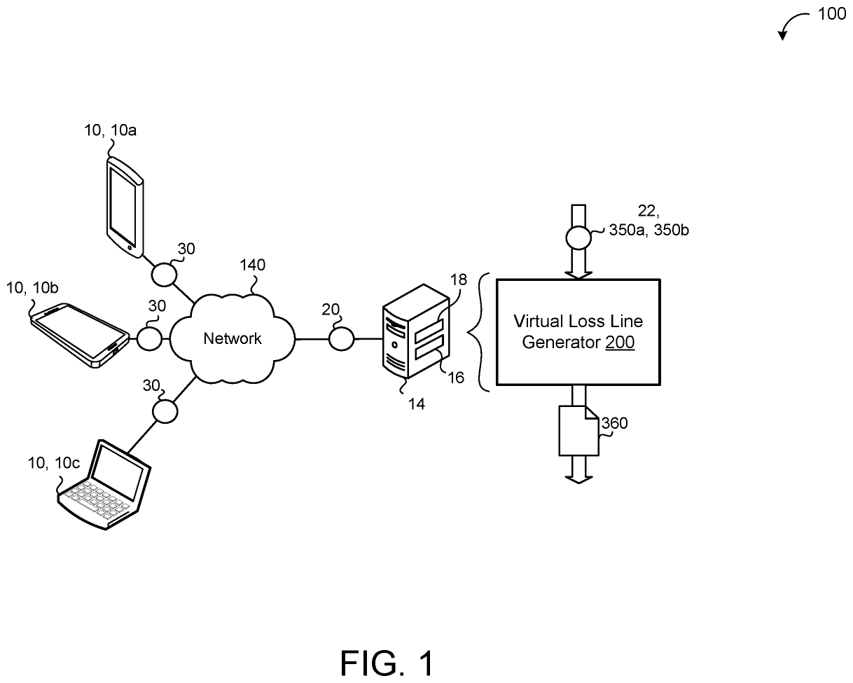

Referring to FIG. 1, in some implementations, an example system 100 includes a processing system 14 in communication with plurality of measuring devices 10, 10a—c via a network 140. The processing system 14 may be a single computer, multiple computers, or a distributed system (e.g., a cloud environment) having scalable/elastic computing resources 16 (e.g., data processing hardware) and/or storage resources 18 (e.g., memory hardware). The processing system 14 executes a virtual loss line generator 200.

The virtual loss line generator 200 sends an EM loss request 20 to each measuring device 10 that requests EM path loss data that characterizes EM loss between two different geographical points. The measuring devices 10 may correspond to any type of consumer or enterprise devices such as cell phones, tablets, laptops, and dedicated EM loss measuring equipment. From each of the measuring devices 10, the virtual loss line generator 200 receives EM path loss values 30. Each EM path loss value 30 represents a quantity of EM loss measured by the measuring device 10 between two different geographical points.

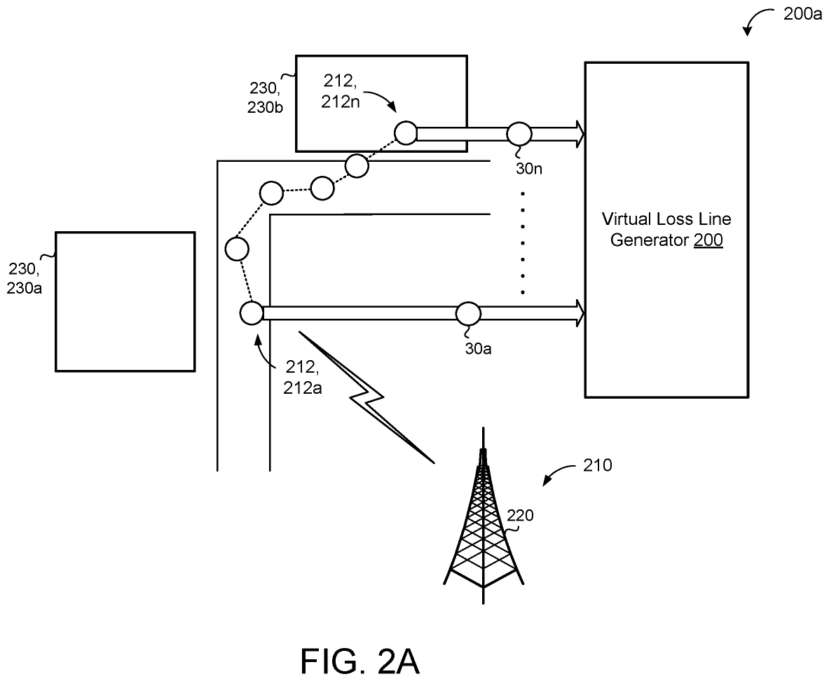

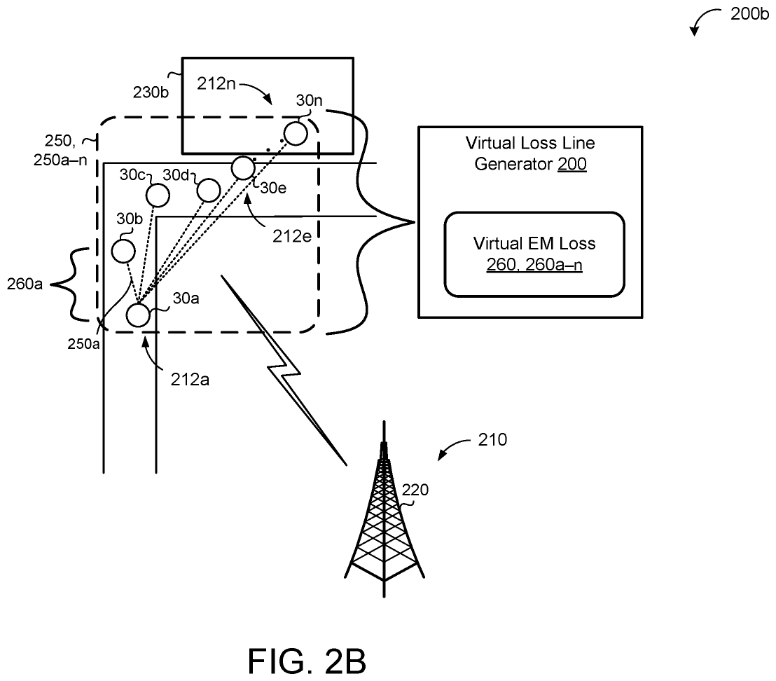

Referring now to FIG. 2A, a schematic view 200a includes a series of EM path loss values 30a-n received by the virtual loss line generator 200. Each EM path loss value 30 is associated with a source geographical point 210, which may be known or unknown aid is not necessary to process. The source geographical point 210 is the location of the emitter the measuring device 10 is in communication with. That is, in some examples, the source geographical point 210 corresponds to a location of a single emitter. In this example, the emitter is cellular base tower 220. Each EM path loss value 30 is also associated with an end geographical point 212, 212a-n (i.e., the location of the measuring device 10 when the EM path loss value 30 is determined). That is, in some implementations, each end geographical point 212 corresponds to a different location of a receiver (e.g., a mobile user device 10). In some examples, for each end geographical point 212 in a set of different end geographical points 212 that share a same source geographical point 210, the virtual loss line generator 200 obtains a respective EM path loss value 30 between the corresponding end geographical point 212 and the source geographical point 210.

In this example, each EM path loss value 30a-n has the same source geographical points 212 and a different end geographical point 212a-n. Here, a user carries the measuring device 10 (not shown) along the street past a first building 230, 230a. As the user carries the measuring device 10, the measuring device 10 periodically or intermittently determines an EM path loss value 30 based on communications received from the emitter (i.e., the cellular base tower 220). For example, the measuring device 10 measures signal strength or some other metric dependent on the signal strength such as coding rate, modulation type and order, error rate, or any other internal metric that relates directly to the received signal level.

The EM path loss value 30 may also include a reference or identifier of the measuring device 10 or the emitter device (e.g., the cellular base tower 220) that the measuring device 10 was communicating with when the EM path loss value 30 was determined. For example, the measuring device 10, at regular intervals (e.g., once per second, once per minute, etc.) determines the current EM path loss value 30 for the current geographical point 212 at the current time with the current cellular base tower 220. The measuring device 10 may determine a new EM path loss value 30 when a threshold period of time has elapsed and/or when the measuring device 10 has traveled a threshold distance and/or when the EM loss has changed a threshold amount from the last measurement.

Referring now to FIG. 2B, in some examples, the virtual loss line generator 200 generates a set of virtual loss lines 250, 250a-n. Each virtual loss line 250 in the set connects a different respective pair of end geographical points 212. For each respective virtual loss line 250 in the set, the virtual loss line generator 200 determines a respective virtual EM loss 260 based on the respective EM path loss values 30 obtained for each end geographical point 212 in the respective pair of end geographical points 212 connected by the respective virtual loss line 250. It is understood that the term “EM path loss value” does not necessarily imply any knowledge of the source of the signal. Instead, as used herein, EM path loss value describes any value determined or measured by the measuring device 10 that describes a quality or strength of the received signal. For example, the value can be based on or equivalent to a signal strength value (or some derivative thereof) measured by the measuring device 10

In schematic view 200b, the virtual loss line generator 200 generates a virtual loss line 250 between the end geographical point 212a and each other end geographical point 212. The virtual loss line generator 200 determines the virtual EM loss 260 of each virtual loss line 250 using the respective pair of EM path loss values 30. For example, the virtual loss line generator 200 determines a first virtual EM loss 260a of a virtual loss line 250a using the EM path loss values 30a, 30b. The virtual loss line generator 200 similarly determines the other virtual EM losses 260 using the other pairs of EM path loss values 30 (e.g., EM path loss values 30a, 30c and EM path loss values 30a, 30d). While not shown in the schematic view 200b for clarity, the virtual loss line generator 200 may generate a virtual loss line 250 for every pair of end geographical points 212 and EM path loss values 30. For instance, the virtual loss line generator 200 generates a virtual loss line 250 between the end geographical points 212e, 212n and determines the corresponding virtual EM loss 260 using the EM path loss values 30e, 30n.

In some implementations, the virtual loss line generator 200 determines a respective virtual EM loss 260 by determining a difference in respective EM path loss values 30 (i.e., the EM path loss value 30 associated with each of the respective pair of end geographical points 212). Attenuative effects are composable in that they accumulate across a path and can be isolated individually. Thus, these attenuative effects can be composed to create models of any path using the relative differences between the EM path loss values 30. For example, when one EM path loss value 30 is equivalent to a 15 dB loss and another EM path loss value 30 is equivalent to a 20 dB loss, and both EM path loss values 30 were measured by the same measuring device 10 in communication with the same emitter (e.g., the same cellular base tower 220), the virtual EM loss 260 between the end geographical points 212 associated with the EM path loss values is 5 dB (i.e., 20 dB less 15 dB). Because the virtual loss line 250 is not an ordered pair, the virtual loss line generator 200, in some implementations, determines the absolute value of the virtual EM loss 260 for each virtual loss line 250, as the loss from x toy is, by electromagnetic symmetry, identical to the loss from y to x.

Referring back to FIG. 1, the virtual loss line generator 200 receives an EM loss request 22 requesting an EM loss 360 between a first requested geographical point 350, 350a and a second requested geographical point 350, 350b. That is, the EM loss request 22 requests that the virtual loss line generator 200 estimate the EM loss a signal would suffer when transmitted from one requested geographical point 350 and received at a different requested geographical point 350. The two requested geographical points 350 may constitute an entirety of the desired loss path or just a segment of it. For example, the two requested geographical points 350a, 350b may make up only a portion (i.e., a segment) of a larger path.

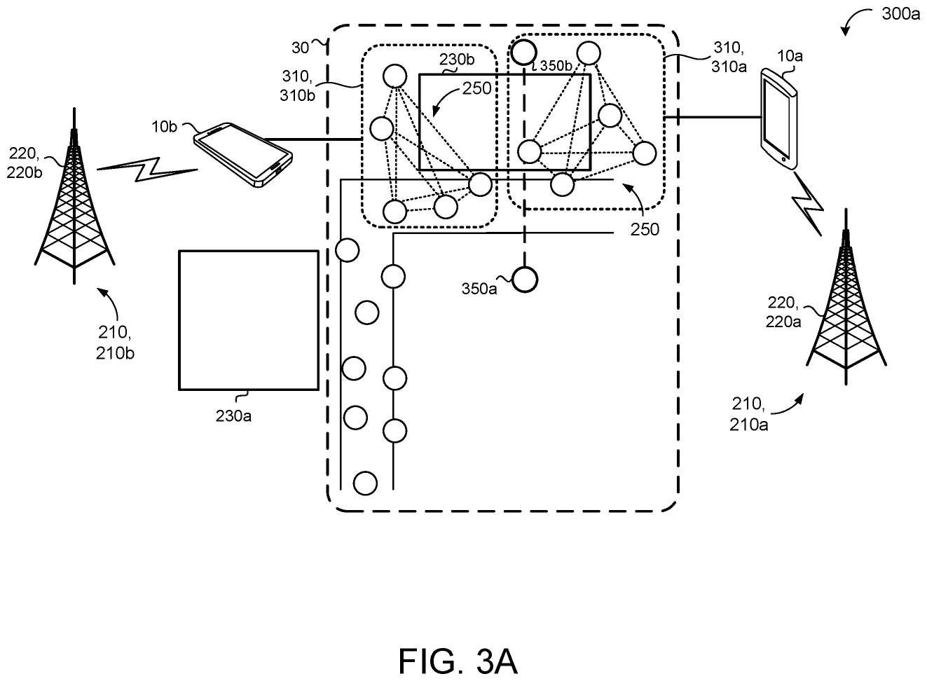

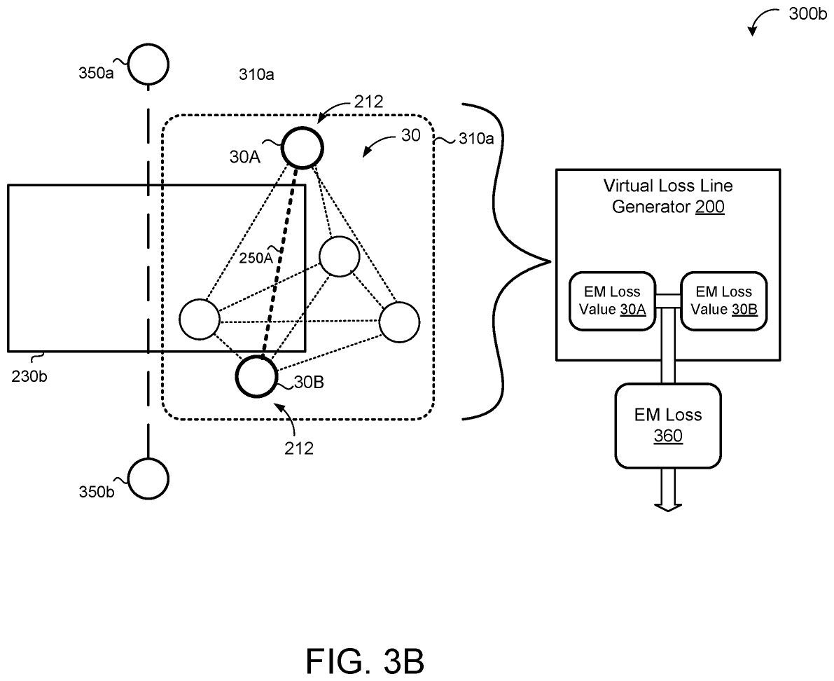

Referring now to FIG. 3A, a schematic view 300a includes a set of EM path loss values 30 obtained by the virtual loss line generator 200. In this example, the virtual loss line generator 200 has received an EM loss request 22 to determine or estimate the EM loss between the first requested geographical point 350a and the second requested geographical point 350b. Here, the requested EM loss path between the first and second requested geographical points 350a, 350b passes through a building 230b. That is, the first requested geographical point 350a is on one side of the building 230b while the second requested geographical point 350b is on the opposite side of the same building 230b.

In some implementations, after receiving the EM loss request 22, the virtual loss line generator 200 selects a subset 310 of different end geographical points 212 or EM path loss values 30 from the set of end geographical points 212 or EM path loss values 30 based on a location associated with the EM loss request 22. For example, the virtual loss line generator 200 selects the EM path loss values 30 that are within a threshold distance of one or both of the requested geographical points 350. It is understood that, because each EM path loss value 30 is associated with a specific end geographical point 212, the two may be discussed interchangeably. In some examples, the virtual loss line generator 200 selects EM path loss values 30 that are near or proximate the requested geographical points 350. For example, when the EM loss request 22 requests an estimation of an EM loss across a building 230, the virtual loss line generator selects a subset 310 of EM path loss values 30 that are proximate the exterior of the building 230 as close to the perimeter as possible.

The virtual loss line generator 200 may select different subsets 310 of different EM path loss values 30 based on the emitter and/or the receiver of the EM path loss values 30. For example, the virtual loss line generator 200 selects EM path loss values 30 that have the same emitter (e.g., the same cellular base tower 220) and the same receiver (e.g., the same measuring device 10). By ensuring that each of the EM path loss values 30 in the subset 310 were measured by the same receiver from the same emitter, differences in calibration, power, antennas, etc. of different devices is eliminated. This allows for the comparison of relative loss differences between the different EM path loss values 30.

In the example of the schematic view 300a, the virtual loss line generator 200 selects two different subsets 310a, 310b of EM path loss values 30. The subset 310a includes EM path loss values 30 determined by a first measuring device 10a in communication with a first cellular base tower 220a. The subset 310b includes EM path loss values 30 determined by a second measuring device 10b in communication with a second cellular base tower 220b. For one or more of the subsets 310, the virtual loss line generator 200 generates virtual loss lines 250 for each pair of EM path loss values 30 in the subset 310. That is, the virtual loss line generator 200 may convolve each of the EM path loss values 30 in one or more subsets 310 to produce all of the possible virtual loss line 250 permutations of the subset 310. Because the EM path loss values 30 are unordered, the symmetric pair (i.e., (x, y) and (y, x)) is not necessary.

Referring now to FIG. 3B, a schematic view 300b includes the subset 310a from FIG. 3A. Here, the virtual loss line generator 200 selects the EM path loss values 30 of the subset 310a and determines the virtual EM loss 260 of each virtual loss line 250. The virtual loss line generator 200, in some examples, estimates the requested EM loss 360 between the first requested geographical point 350a and the second requested geographical point 350b based on the virtual EM losses 260 determined for the virtual loss lines 250. In this example, the virtual loss line generator 200 determines that a virtual loss line 250A most closely resembles the requested path between the requested geographical points 350a, 350b as it traverses the building 230b at approximately the same orientation.

However, the virtual loss line generator 200 may estimate the EM loss 360 using the EM path loss values 30 in a number of ways. Assuming a sufficient set of crowd-sourced data, the resulting virtual loss lines 250 provide a range of obstruction entry points, crossing angles, and even altitudes when working in three dimensions. For example, EM path loss values 30 may be taken from different floors of the same building. The most appropriate of the EM path loss values 30 can be selected for use. When there is sufficient redundancy, multiple virtual loss lines 250 may be aggregated statistically. That is, in some implementations, after generating the set of virtual loss lines 250, the virtual loss line generator 200 determines a subset of virtual loss lines 250 of the set of virtual loss lines 250 that satisfy an aggregation threshold and, in response to determining that the subset of virtual loss lines 250 satisfy the aggregation threshold, aggregates the subset of virtual loss lines 250 into a single aggregated virtual loss line. The virtual loss line generator 200 may employ machine-learning to select one or more virtual loss lines 250 to best simulate the requested path loss.

Optionally, the virtual loss line generator can further refine the EM loss 360 estimates by applying the principle of composability to the virtual loss line 250 by combining or subtracting various losses to further refine the EM loss 360 for situations when no adequate virtual loss line 250 is available. In some examples, the virtual loss line generator 200 determines a free space loss value based on a distance between the corresponding end geographical point 212 and the source geographical point 210 and adjusts the respective EM path loss value 30 based on the determined free space loss value. The virtual loss line generator 200 may adjust the respective EM path loss value 30 by subtracting the determined free space loss value from the respective EM path loss value 30.

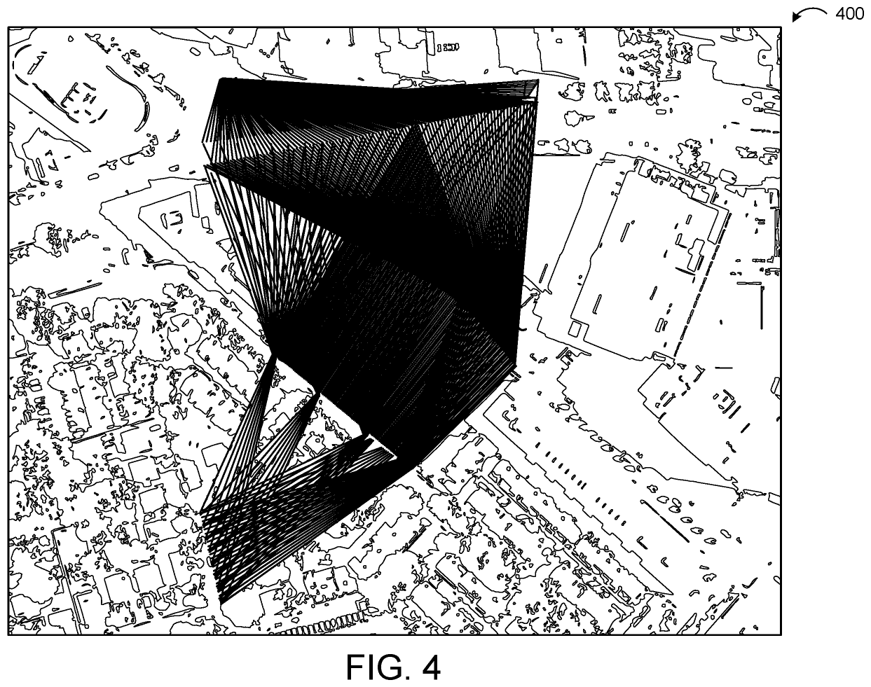

Referring now to FIG. 4, an exemplary EM virtual crowed-sourced path map 400 provides a satellite view of a geographic area overlain with several EM path loss values 30 captured by measuring devices 10. Virtual loss lines 250 connect many of the EM path loss values providing estimates at various angles through various structures.

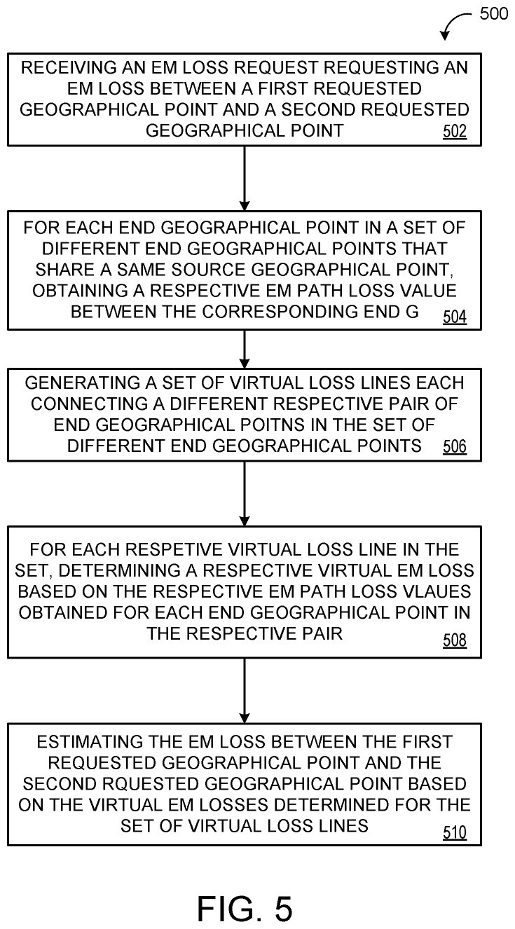

FIG. 5 is a flowchart of an exemplary arrangement of operations for a method 500 for interpolating crowd-sourced electromagnetic propagation estimation of indirect paths. The method 500, at step 502, includes receiving an EM loss request 20 requesting an EM loss 360 between a first requested geographical point 350a and a second requested geographical point 350b. For each end geographical point 212 in a set of different end geographical points 212 that share a same source geographical point 210, the method 500 includes, at step 504, obtaining a respective EM path loss value 30 between the corresponding end geographical point 212 and the source geographical point 210. At step 506, the method 500 includes generating a set of virtual loss lines 250. Each virtual loss line 250 in the set of virtual loss lines 250 connects a different respective pair of end geographical points 212 in the set of different end geographical points 212. For each respective virtual loss line 250 in the set of virtual loss lines 250, the method 500 includes, at step 508, determining a respective virtual EM loss 260 based on the respective EM path loss values 30 obtained for each end geographical point 212 in the respective pair of end geographical points 212 connected by the respective virtual loss line 250. The method 500, at step 510, includes estimating the EM loss 360 between the first requested geographical point 350a and the second requested geographical point 350b based on the virtual EM losses 260 determined for the set of virtual loss lines 250.

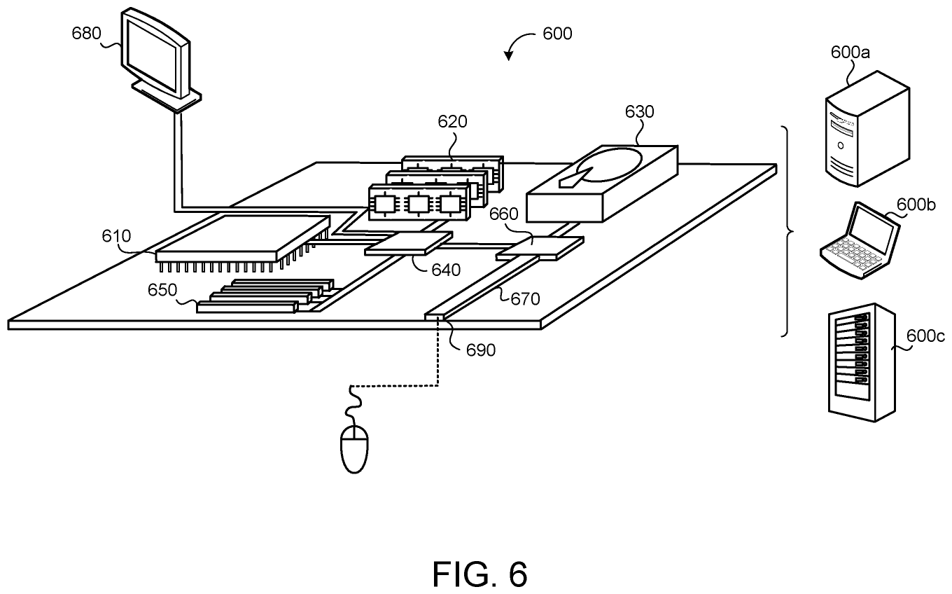

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving an electromagnetic (EM) loss request requesting an EM loss between a first requested geographical point and a second requested geographical point;
for each end geographical point in a set of different end geographical points that share a same source geographical point, obtaining a respective EM path loss value between the corresponding end geographical point and the source geographical point;
generating a set of virtual loss lines, each virtual loss line in the set of virtual loss lines connecting a different respective pair of end geographical points in the set of different end geographical points;
for each respective virtual loss line in the set of virtual loss lines, determining a respective virtual EM loss based on the respective EM path loss values obtained for each end geographical point in the respective pair of end geographical points connected by the respective virtual loss line; and
estimating the EM loss between the first requested geographical point and the second requested geographical point based on the virtual EM losses determined for the set of virtual loss lines.

2. The method of claim 1, wherein the operations further comprise, after receiving the EM loss request, selecting the set of different end geographical points from a superset of end geographical points based on a location of the EM loss request.

3. The method of claim 1, wherein:
the source geographical point corresponds to a location of a single emitter; and
each end geographical point in the set of different end geographical points corresponds to a different location of a receiver.

4. The method of claim 3, wherein the receiver comprises a mobile user device.

5. The method of claim 3, wherein the single emitter comprises a cellular base station.

6. The method of claim 1, wherein the set of virtual loss lines comprises a virtual loss line for every pair of end geographical points in the set of different end geographical points.

7. The method of claim 1, wherein, for each respective virtual loss line in the set of virtual loss lines, determining the respective virtual EM loss comprises determining a difference between the two respective EM path loss values obtained for each end geographical point in the respective pair of end geographical points connected by the respective virtual loss line.

8. The method of claim 1, wherein the operations further comprise, for each respective EM path loss value:
determining a free space loss value based on a distance between the corresponding end geographical point and the source geographical point; and
adjusting the respective EM path loss value based on the determined free space loss value.

9. The method of claim 8, wherein adjusting the respective EM path loss value comprises subtracting the determined free space loss value from the respective EM path loss value.

10. The method of claim 1, wherein the operations further comprise, after generating the set of virtual loss lines:
determining a subset of virtual loss lines of the set of virtual loss lines that satisfy an aggregation threshold; and
in response to determining that the subset of virtual loss lines satisfy the aggregation threshold, aggregating the subset of virtual loss lines into a single aggregated virtual loss line.

11. A system comprising:
data processing hardware; and
memory hardware in communication with the data processing hardware, the memory hardware storing instructions that when executed on the data processing hardware cause the data processing hardware to perform operations comprising:
receiving an electromagnetic (EM) loss request requesting an EM loss between a first requested geographical point and a second requested geographical point;
for each end geographical point in a set of different end geographical points that share a same source geographical point, obtaining a respective EM path loss value between the corresponding end geographical point and the source geographical point;
generating a set of virtual loss lines, each virtual loss line in the set of virtual loss lines connecting a different respective pair of end geographical points in the set of different end geographical points;
for each respective virtual loss line in the set of virtual loss lines, determining a respective virtual EM loss based on the respective EM path loss values obtained for each end geographical point in the respective pair of end geographical points connected by the respective virtual loss line; and
estimating the EM loss between the first requested geographical point and the second requested geographical point based on the virtual EM losses determined for the set of virtual loss lines.

12. The system of claim 11, wherein the operations further comprise, after receiving the EM loss request, selecting the set of different end geographical points from a superset of end geographical points based on a location of the EM loss request.

13. The system of claim 11, wherein:
the source geographical point corresponds to a location of a single emitter; and
each end geographical point in the set of different end geographical points corresponds to a different location of a receiver.

14. The system of claim 13, wherein the receiver comprises a mobile user device.

15. The system of claim 13, wherein the single emitter comprises a cellular base station.

16. The system of claim 11, wherein the set of virtual loss lines comprises a virtual loss line for every pair of end geographical points in the set of different end geographical points.

17. The system of claim 11, wherein, for each respective virtual loss line in the set of virtual loss lines, determining the respective virtual EM loss comprises determining a difference between the two respective EM path loss values obtained for each end geographical point in the respective pair of end geographical points connected by the respective virtual loss line.

18. The system of claim 11, wherein the operations further comprise, for each respective EM path loss value:
determining a free space loss value based on a distance between the corresponding end geographical point and the source geographical point; and
adjusting the respective EM path loss value based on the determined free space loss value.

19. The system of claim 18, wherein adjusting the respective EM path loss value comprises subtracting the determined free space loss value from the respective EM path loss value.

20. The system of claim 11, wherein the operations further comprise, after generating the set of virtual loss lines:
determining a subset of virtual loss lines of the set of virtual loss lines that satisfy an aggregation threshold; and
in response to determining that the subset of virtual loss lines satisfy the aggregation threshold, aggregating the subset of virtual loss lines into a single aggregated virtual loss line.
